(19) United States
(12) Patent Application Publication
(10) Pub. No.: US 2006/0215205 A1
(43) Pub. Date: Sep. 28, 2006

(54) Image processing apparatus, image processing method and image processing program

(76) Inventors: Maki Ohyama, Kanagawa (JP); Hiroyuki Kawamoto, Kanagawa (JP); Satoshi Ohkawa, Tokyo (JP); Naoki Sugiyama, Kanagawa (JP); Hiroshi Arai, Saitama (JP); Yasunobu Shirata, Tokyo (JP); Atsushi Togami, Kanagawa (JP); Takeharu Tone, Kanagawa (JP); Taira Nishida, Tokyo (JP); Isao Miyamoto, Kanagawa (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/384,523

(22) Filed: Mar. 21, 2006

(30) Foreign Application Priority Data
Mar. 22, 2005 (JP) 2005-082829 (JP)

(51) Int. Cl. G06F 3/12

(52) U.S. Cl. 358/1.13; 358/1.15

(57) ABSTRACT

An image processing apparatus of the present invention includes a control panel for allowing an application mode selector an image quality mode to be selected. A reading unit generates a preselected color image signal by reading a document image. A scanner corrector executes image processing with the color image signal in accordance with the application and the image mode selected by on the control panel to thereby generate color image data. A storage stores the image data generated by the scanner corrector and information representative a processing mode based on the application and image mode selected on the control panel. A data compressor/expander selectively compresses or expands the image data. A data format converts the format of the image data stored in the storage in matching relation to the processing mode.

### BACKGROUND OF THE INVENTION

1. Field of the Invention

The present invention relates to an image processing apparatus, an image processing method and an image processing program for executing various kinds of image processing with a document image read from a document to thereby generate image data.

2. Description of the Background Art

A network scanner technology known in the imaging art connects a digital copier, image reading apparatus or similar imaging apparatus to a network, scans a document image with a scanner customarily included in such an apparatus, and sends image data read from the document to a computer or similar terminal also connected to the network. Various network scanner technologies are disclosed in, e.g., Japanese patent laid-open publication Nos. 6-332636 (Prior Art 1 hereinafter), 10-190927 (Prior Art 2 hereinafter), 2000-333026 (Prior Art 3 hereinafter), 2001-157039 (Prior Art 4 hereinafter), 2001-16453 (Prior Art 5 hereinafter), 2001-223828 (Prior Art 6 hereinafter) and 2001-251522 (Prior Art 7 hereinafter) as well as in Japanese patent publication No. 2001-506835 (Prior Art 8 hereinafter).

Among Prior Arts 1 through 8 mentioned above, Prior Art 3 teaches a processing sequence using a scanner box function. More specifically, the processing sequence selects resolution, gradation, magnification and a surface to read, an image size, a storage and other scan parameters, then reads an image and then transfers the resulting image read to an image processor and causes it to process the image in accordance with the scan parameters. Because this processing sequence is not expected to print the image, it is not necessary to generate a data format for a printing system and therefore to effect color coordinates conversion from R (red), G (green) and B (blue) to C (cyan), M (magenta), Y (yellow) and K (black), gradation correction or image data compression.

The image data thus processed by the image processor are transferred to an extension box based on the architecture of a general-purpose computer system. In the extension box, the image data are temporarily written to a scan box assigned to a preselected disk area in a hard disk drive. After all document pages have been stored in the extension box, a client of the network produces the image data from the scan box.

However, Prior Art 3 has a problem that the format of the image data subject to processing for copying and the format of the image data subject to processing for the distribution of a scan box, images printed by the same digital image processing apparatus are different from each other. Further, in Prior Art 3, the operator pushes a copy button to produce a copy image when intending to copy a document or pushes a scan button to produce an image for distribution when intending to distribute a document. The operator therefore must scan the same document two times when intending to copy a document and distributing it, resulting in time- and labor-consuming work.

Moreover, in Prior Art 3, the image data stored in the hard disk drive are, in many cases, provided with a format to be deal with by a digital copier. This, coupled with the fact that the image data are sometimes compressed by an exclusive algorithm when compressed for saving memory capacity, prevents the operator from reading or editing the image with a general-purpose application.

Prior Art 6 proposes a technology for controlling multiple functions including a copy function, a scanner function, a printer function and a facsimile function. For this purpose, Prior Art 6 generates image data representative of an image read and attribute data derived from the image data and stores the image data and pixel-based attribute data associated therewith in an image storage in association with each other. When the image data should be sent to an outside client apparatus, the image data are transformed to a preselected format.

The problem with Prior Art 6 is that a processing mode selected on a control panel is not written to the image storage or hard disk drive. As a result, when the image data stored in the hard disk drive should be sent to an outside client apparatus, the image data are converted to a file format without regard to the processing mode selected on the control panel. Further, a great amount of attribute data must be dealt with in addition to the image data, scaling up the system.

### SUMMARY OF THE INVENTION

It is an object of the present invention to provide an image processing apparatus capable of enhancing efficient data transmission and general-purpose use of data by producing from read document image from small-capacity image data of a format that can be shared by a plurality of image processing apparatuses.

It is another object of the present invention to provide an image processing method and an image processing program using the above image processing apparatus each.

An image processing apparatus of the present invention includes an application mode selector configured to select an application and an image quality mode selector configured to select an image quality mode. A reading section generates a preselected color image signal by reading a document image. A scanner corrector executes image processing with the color image signal in accordance with the application and image mode selected by the application mode selector and image mode selector, respectively, to thereby generate color image data. A storage stores the image data generated by said scanner corrector and information representative a processing mode based on the application and the image mode selected. A data compressor/expander selectively compresses or expands the image data. A data format converter converts the format of the image data stored in the storage in matching relation to the processing mode. A communicating circuit interchanges various data with an external apparatus. A controller controls the entire apparatus.

An image processing method and an image processing program using the above image processing apparatus each are also disclosed.

### BRIEF DESCRIPTION OF THE DRAWINGS

The above and other objects, features and advantages of the present invention will become more apparent from the following detailed description taken with the accompanying drawings in which:

FIG. 1 is a schematic block diagram showing a preferred embodiment of the image processing apparatus embodying the present invention;

FIG. 2 is a schematic block diagram showing a specific configuration of a scanner corrector included in the illustrative embodiment;

FIG. 3 is a plan view showing a specific arrangement of a control panel mounted on the outside of the apparatus body;

FIG. 4 is a schematic block diagram showing a specific configuration of a printer corrector included in the illustrative embodiment;

FIG. 5 a schematic block diagram demonstrating the transmission of image data stored in a hard disk drive included in the illustrative embodiment to an outside PC;

FIG. 6 is a block diagram schematically showing a specific configuration of a data format converter included in the illustrative embodiment;

FIGS. 7, 8 and 9 are schematic block diagrams each showing a specific case of conversion effected by the data format converter;

FIGS. 10A is a schematic block diagram showing a specific configuration of a resolution converter included in the illustrative embodiment;

FIG; 10B is a schematic block diagram showing a specific configuration of a main-scan resolution conversion block forming part of the a converter;

FIG. 10C is a schematic block diagram showing a specific configuration of a subscan resolution conversion block forming part of the resolution converter;

FIGS. 11A, 11B and 11C demonstrate color space conversion executed by a color space converter included in the data format converter;.

FIG. 12 is a flowchart showing a specific image data generation and transmission sequence unique to the illustrative embodiment;

FIG. 13 is a flowchart showing a specific image data format conversion sequence also unique to the illustrative embodiment;

FIG. 14 is a schematic block diagram showing a data format converter representative of an alternative embodiment of the present invention;

FIG. 15 is a block diagram schematically showing another specific configuration of the data format converter;

FIG. 16 shows a matrix usable for the removal of solitary points; and

FIG. 17 is a schematic block diagram showing specific image data transmission stored in the hard disk drive of the alternative embodiment to outside PCs.

### DESCRIPTION OF THE PREFERRED EMBODIMENTS

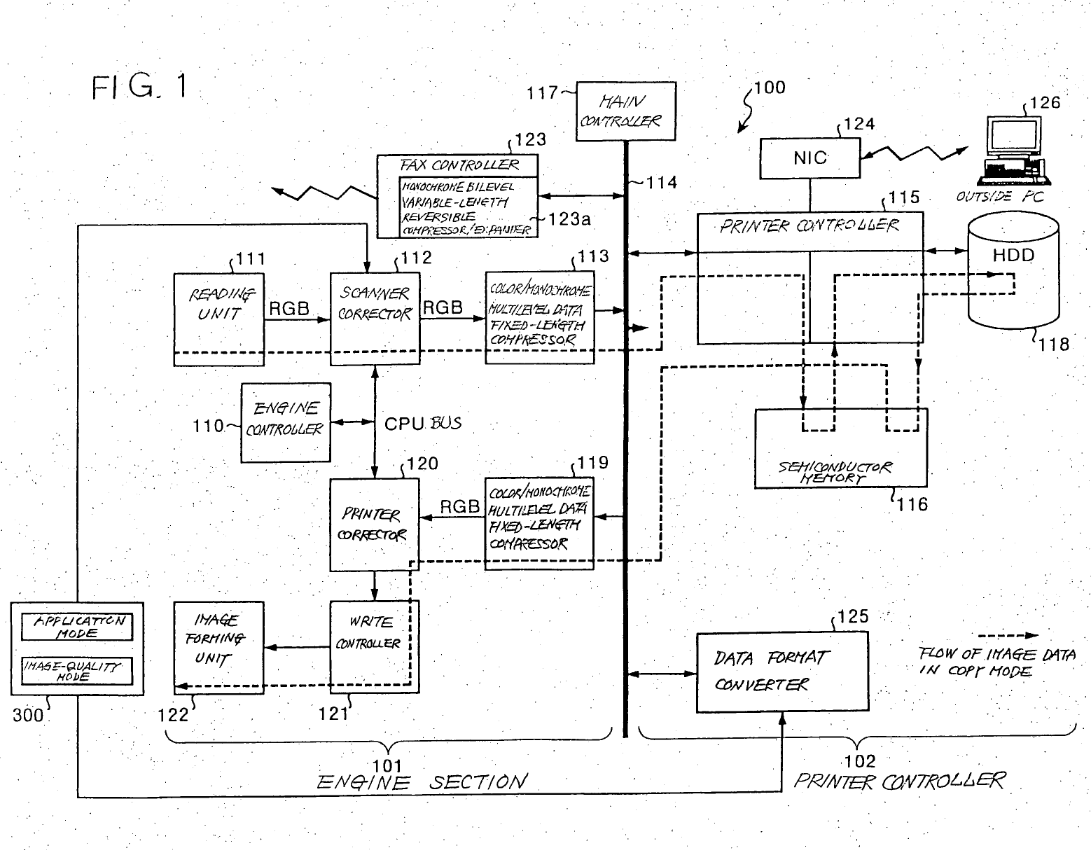

Referring to FIG. 1 of the drawings, an image processing apparatus embodying the present invention is shown and implemented as a multifunction machine having a copying function, a printing function and so forth. In FIG. 1, arrows indicate the flow of image data. As shown, the image forming apparatus, generally 100, is generally made up of an engine controller 101 and a printer controller 102.

An engine control controller 110 is included in the engine section 101 for controlling the entire engine section 101. In the engine section 101, a reading unit or image reading means 111 reads a document image to thereby output image data consisting of an R, (red), a G (green) and a B (blue) component and sends such image data to a scanner corrector 112.

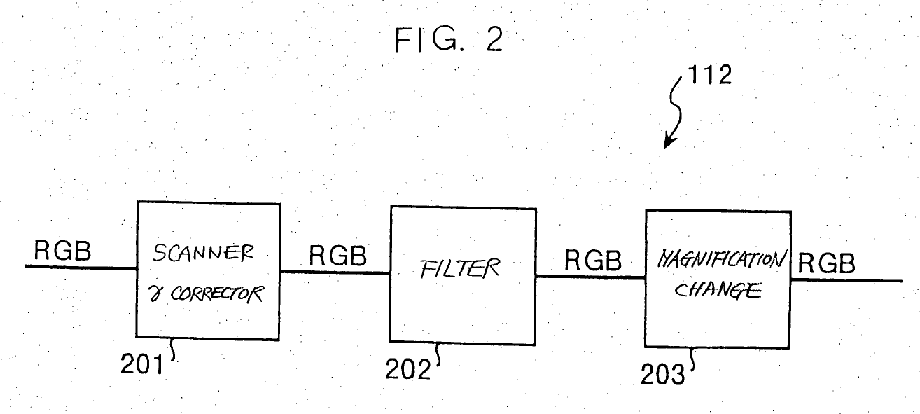

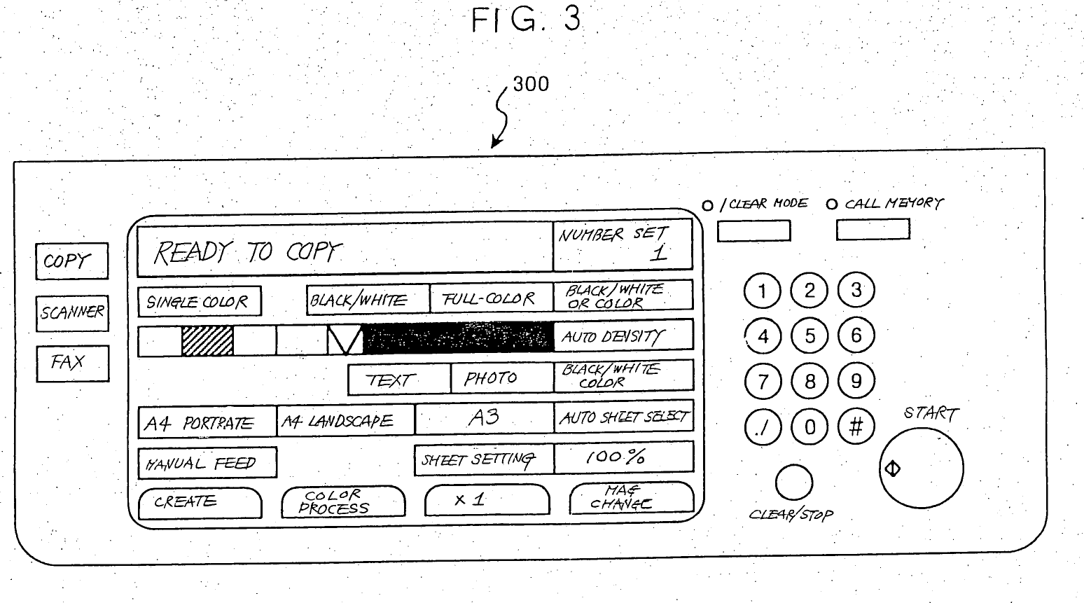

As shown in FIG. 2, the scanner corrector 112 includes a scanner γ corrector 201 for executing scanner γ correction with the RGB image data a filter 202 for filtering the resulting RGB image data output from the scanner γ corrector 201, and a magnification changer 203 for changing the magnification of the filtered R, G and B image data. It is to be noted such a sequence reflects processing modes selected by application mode selecting means and image quality mode selecting means, generally 300. Such processing modes are selected by the operator on a control panel 300, see FIG. 3, mounted on the outside of the casing of the image processing apparatus 100.

The application mode mentioned above refers to a copy mode, a scanner mode, a facsimile mode or the like while the image quality mode refers to a text mode, a text/photo mode, a photo mode or the like as well as notch information for increasing or decreasing image density.

The R, G, and B image data, having eight bits each, output from the scanner corrector 112, FIG. 2, are transformed to R, G and B image data having n bits (n≦8) each by a color/monochrome multilevel data fixed-length compressor 113 and then sent to a printer controller 115 via a general-purpose bus 114.

The printer controller 115 includes a semiconductor memory 116 for storing the input image data under the control of a main controller 117. The main controller 117 includes a microcomputer, not shown, and controls the entire image processing apparatus 100. The image data stored in the semiconductor memory 116 and information representative of processing modes selected on the operation panel 300 are written to an HDD (Hard Disk Drive) or storing means 118. This successfully makes it unnecessary to repeatedly read the same document even when the image data are not fully printed out due to a sheet jam and to effect electronic sorting. Today, document images read are written to the HDD 118 in addition to the above image data and information, so that the document images can be again output, as needed.

When the image data stored in the HDD 118 should be output, they are once transferred to the semiconductor memory 116 of the printer controller 115 and then sent to the engine section 101 via the general-purpose bus 114. A color/monochrome multilevel data fixed-length expander 119, included in the engine section 101, converts the input image data to R, G and B image data each having eight bits. The R, G and B data thus produced are sent to a printer corrector 120. It should be noted that the color/monochrome multilevel fixed-length compressor 113 and color/monochrome multilevel fixed-length expander 119 may be respectively replaced with a general-purpose compressor and a general-purpose expander not fixed in length, if desired. The image data once written to the semiconductor memory 116 are written to the hard disk 118. Why the image data stored in the HDD 118 are written to the semiconductor memory 116 before fed to a plotter is that the writing speed and reading speed of the HDD 118 are not constant.

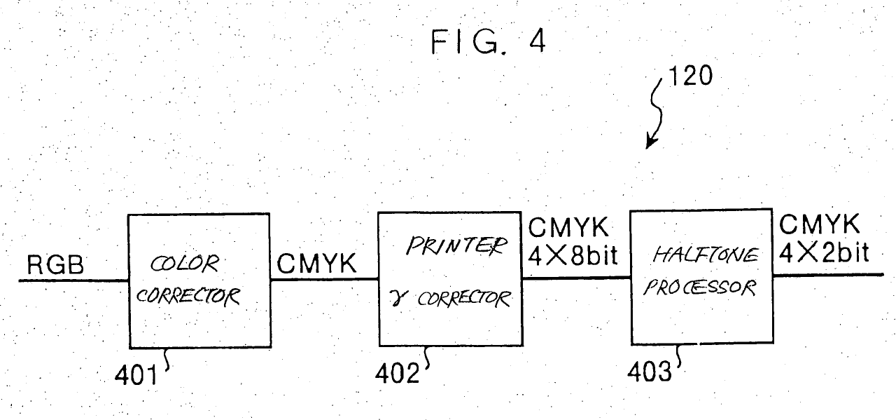

FIG. 4 shows a specific configuration of the printer controller 120. As shown, the printer controller 120 includes a color corrector 401 for converting the R, G and B image data received from the color/monochrome multilevel data fixed-length expander 119 to C (cyan), M (magenta), Y (yellow) and K (black) color signals. The C, M, Y and K color signals are then input to a printer γ corrector 402 and subject to γ correction thereby. Subsequently, the C, M, Y and K signals are subject to halftone processing by a halftone processor 403 in matching relation to a write controller 121 and an image forming unit 122 and then fed to the following stage as image data to be printed out.

It is to be noted that the steps described so far are executed in accordance with processing modes stored in the HDD 118. The image forming unit 122 may be implemented by any one of conventional image forming systems including an electrophotographic system, an ink jet system, a sublimation type thermal transfer system, a silver-halide type photographic system, a direct thermosensitive recording system and a melt type thermal transfer system.

A FAX (facsimile) controller 123 is configured to interchange image data with a preselected network, e.g., a telephone network. A monochromatic bilevel variable-length reversible compressed data expander 123a, included in the FAX controller 123, compresses data to be transmitted to the network or extends data received from the network.

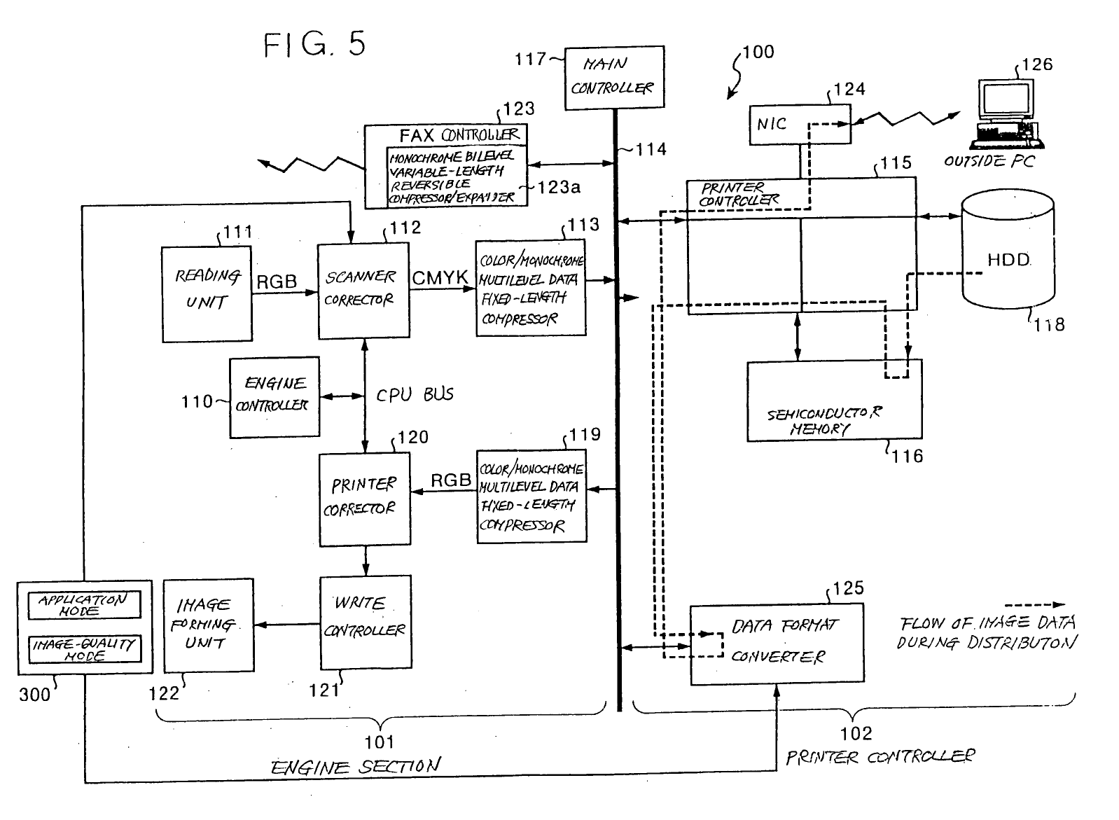

Reference will be made to FIG. 5 for describing a specific procedure for transmitting data stored in the HDD 118 to an outside PC (Personal Computer) 126. An NIC (Network Interface Controller) 124 plays the role of an interface for connecting the image processing apparatus 100 to a LAN (Local Area Network) or similar network. The configuration and operation of a data format converter 125 will be described specifically later.

The HDD 118 stores the image data subject to scanner correction, i.e., image processing for copying and information representative of the processing modes input from the control panel 300, as stated earlier. The processing modes, including an application mode and an image quality mode, are input on the control panel 300, FIG. 3, by the operator. The application mode may be a copy mode, a scanner mode, a facsimile mode or the like while the image quality mode may be a text mode, a text/photo mode, a photo mode or the like. In addition, the image quality mode includes notch information indicative of an increase or a decrease in image density.

The image data stored in the HDD 118 are once stored in the semiconductor memory 116 of the printer controller 115 and then sent to the data format converter 125 via the general-purpose bus 114 together with information representative of the processing modes selected. The data format converter 125 executes image processing matching with the processing modes and processes the image data to an adequate image format to be distributed. The image data thus processed are distributed to the outside PC 126 via the NIC 124. Also, information representative of the processing modes of desired image data may be sent from the outside PC 126 to the image processing apparatus 100, if desired. In such a case, the main controller 117 detects such information and delivers it to the data format converter 125, so that the image data are formatted in accordance with the modes desired by the operator of the outside PC 126.

In the description made so far, the hard disk 118 is assumed to store image data subject to image processing for copying and compressed in the RGB color space. The image data stored in the hard disk 118 are data read by, e.g., a color copier as a copy image and belonging to a certain color space, which may be a Yuv or CMY color space dependent on the kind or characteristic of a device or an sRGB color space not dependent of the same. When the signals belonging to a certain color space are to be sent to the other apparatus via a network, they are corrected to belong to the same color space as the other apparatus. The certain color space may be the standard sRGB space, an Lab space or an exclusive color space that can be shared by different apparatuses.

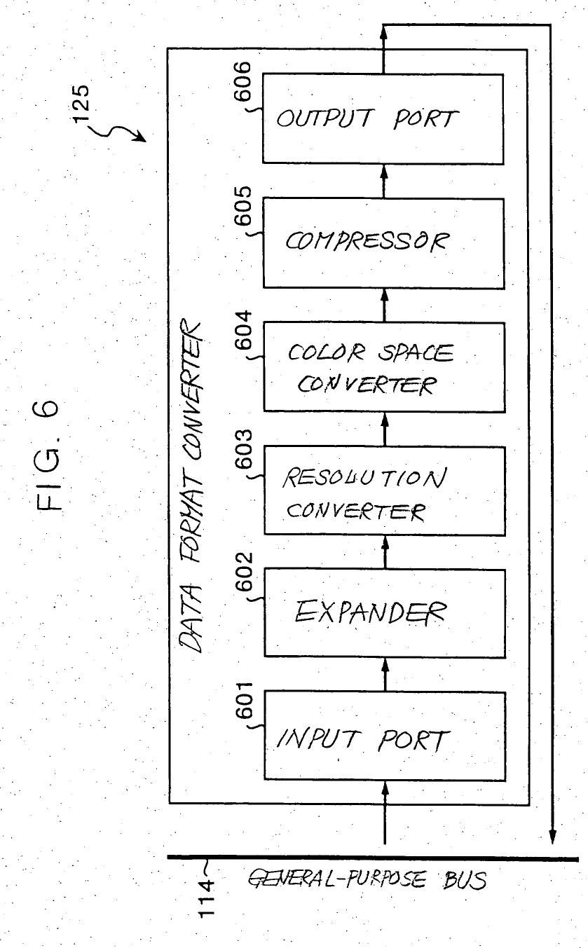

FIG. 6 is a block diagram schematically showing a specific configuration of the data format converter 125. As shown, the image data and processing mode information output from the HDD 118 are input to an input port 601 via the general-purpose bus 114. The image data in a compressed state are then expanded by an expander 602. The image data thus expanded are provided with a resolution based on the processing mode by a resolution converter 603 and then converted to a color space also based on the processing mode by a color space converter 604. The resulting output of the color space converter 604 is coded by a compressor.605 in a preselected compression format, fed to the general-purpose bus 114 via an output port 606 and then sent to the outside PC 12. In this manner, the image data stored in the HDD 118 in a first format are sent as image data having a second format.

More specific configurations of the data format converter 125 will be described hereinafter.

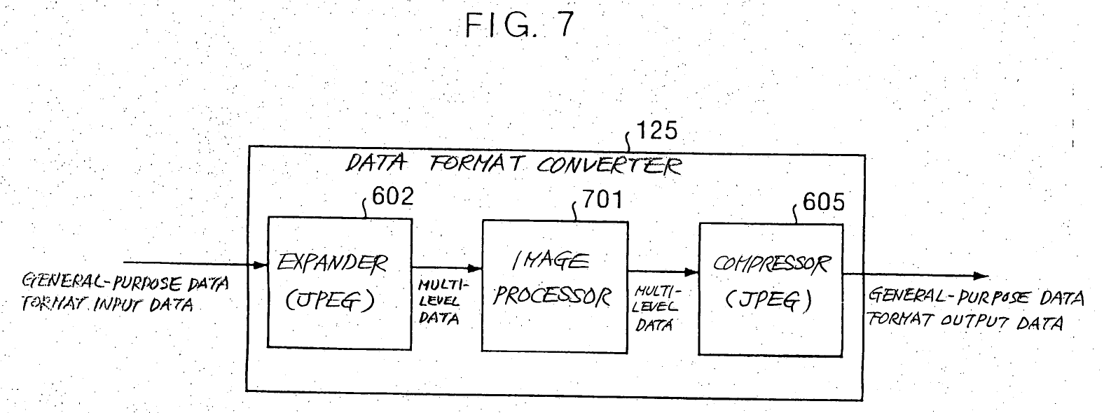

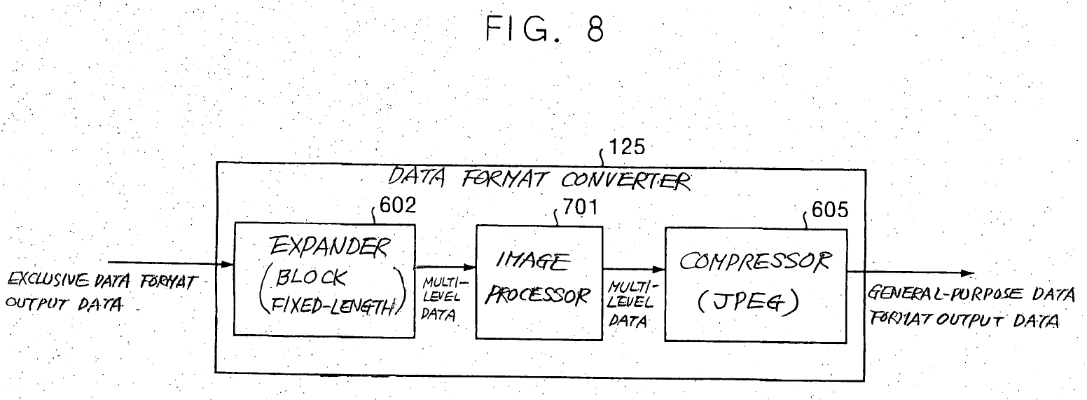

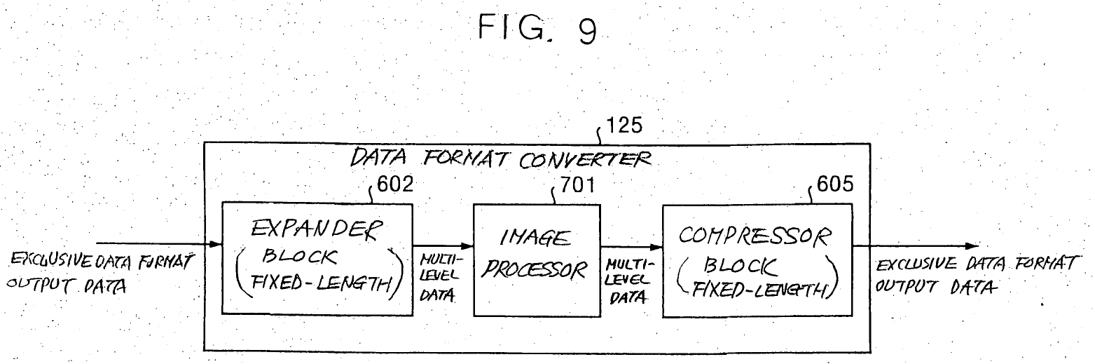

FIG. 7 shows a first specific configuration in which the image data input to the data format converter 125 are multilevel data provided with a general-purpose data format by a multilevel data compression system. More specifically, the expander 602 and compressor 605 execute expansion and compression, respectively, in a general-purpose data format. In FIG. 7, an image processor 701 includes the resolution converter 603 and color space converter 604. The input port 601 and output port 606 are not shown in FIG. 7. This is also true with FIGS. 8 and 9 to follow.

In the above first configuration, the expander 602 expands the image data compressed by the JPEG (Joint Photographic Experts Group) system to thereby restore multilevel data. The expanded image data output from the expander 602 are subject to image processing by the image processor 701 on the basis of the processing modes stated earlier. Subsequently, the image data are again compressed by the compressor 605 by the JPEG system and provided with the general-purpose data format thereby. Of course, the JPEG system used for compression may be replaced with any other general-purpose data format customary with personal computers, e.g., the JPEG 2000 system.

By interchanging data in the JPEG or similar standardized general-purpose data format, it is possible to uniform the data format between a transmitting unit and a receiving unit. It is also possible to implement a data format conversion system insuring both of high data quality and high data interchange efficiency. Further, when the image data are bilevel, there may be used the MHMR/MMR system or similar general-purpose format standardized for data compression and expansion.

FIG. 8 shows a second specific configuration in which the image data to be input to the data format converter 125 are compressed in a data format exclusive to the image processing apparatus 100 while output image data are provided with a general-purpose data format as in the configuration of FIG. 7. It should be noted that an exclusive format refers to a data format particular to the image processing apparatus 100 and different from the JPEG, JPEG 2000 or similar general-purpose data format customary with, e.g., personal computers. For this reason, the expander 602 uses an exclusive fixed-length block expansion system. The compressor 605 uses a general-purpose data format as in the configuration of FIG. 7.

In the configuration shown in FIG. 8, the expander 602 expands the image data input in the exclusive fixed-length block compressed state to thereby restore multilevel data. Subsequently, the image processor 701 executes image processing with the restored multilevel data in accordance with the processing modes stated previously. Thereafter, the compressor 605 executes JPEG compression with the image data, so that the image data are output in the general-purpose data format.

As stated above, the data format converter 125 shown in FIG. 8 deals with exclusive fixed-length block compressed data as an exclusive data format and can therefore manage especially the variation of a compression ratio dependent on image data by fixing it. Further, by handling the image data on a block basis, the data format converter 125 can easily rotate, rearrange or otherwise process the image data. A fixed-length block coding and decoding system is disclosed in, e.g., Japanese patent laid-open publication No. 11-331844 and will not be described specifically. When the image data are implemented as bilevel data, use may be made of a system taught in, e.g., Japanese patent laid-open publication No. 2002-077627.

Moreover, by transmitting image data in the JPEG or similar standardized general-purpose format, it is possible to uniform the data format between a sending unit and a receiving unit and to construct a data format conversion system achieving both of high data quality and high data interchange efficiency. When the image data are implemented as bilevel data, use may be made of the MHMR/MMR or similar standardized general-purpose compression/expansion format.

FIG. 9 shows a third specific configuration identical with the configuration of FIG. 8 except that the output image data are subject to compression in the same data format as the input image data, i.e., the data format exclusive to the image processing apparatus 100. The compressor 605 therefore compresses the image data in the exclusive data format by fixed-length block compression.

As stated above, the data format converter 125 shown in FIG. 9 also deals with exclusive fixed-length block compressed data as an exclusive data format and can therefore manage especially the variation of a compression ratio dependent on image data by fixing it. Further, by handling the image data on a block basis, the data format converter 125 can easily rotate, rearrange or otherwise process the image data. Again, the fixed-length block coding and decoding system disclosed in, e.g., Japanese patent laid-open publication No. 11-331844 may be used. Also, when the image data are implemented as bilevel data, use may be made of a system taught in, e.g., Japanese patent laid-open publication No. 2002-077627.

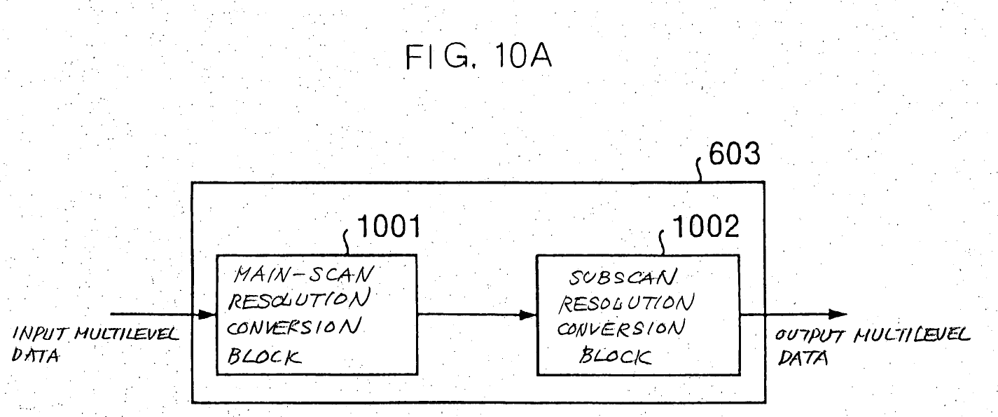

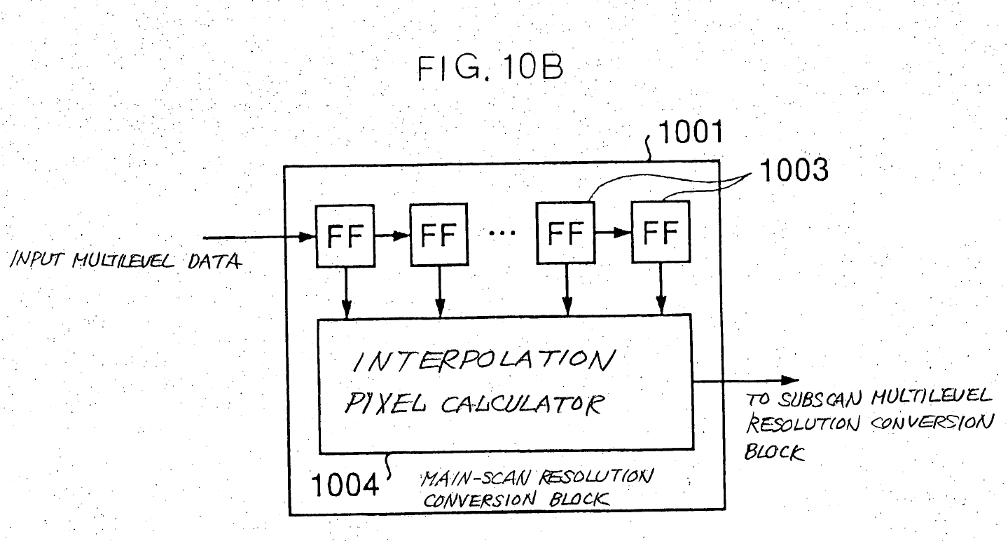

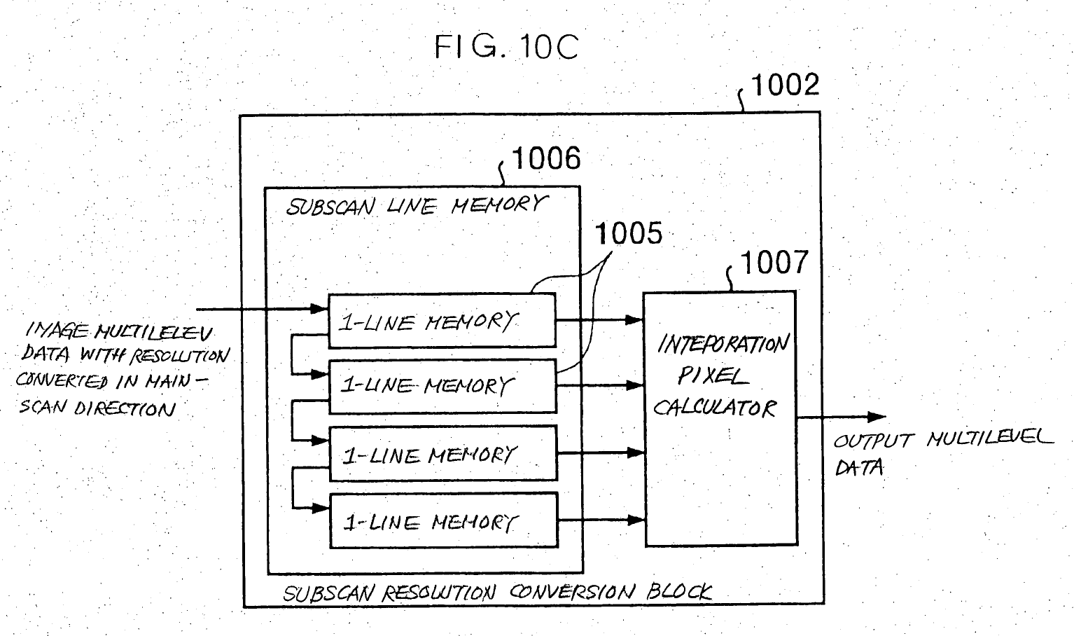

The resolution converter 603 will be described specifically hereinafter on the assumption that the image data to be dealt with are multilevel data and can be varied in resolution in both of the main scanning direction and subscanning direction, as desired. As shown in FIG. 10A, the resolution converter 603 is generally made up of a main-scan resolution conversion block 1001 and a subscan resolution conversion block 1002. The main-scan resolution conversion block 1001 converts the resolution of the input multilevel data in the main scanning direction on the basis of the processing modes selected. Subsequently, the subscan resolution conversion block 1002 converts the resolution of the multilevel data thus converted in resolution in the main scanning direction in the subscanning direction.

As shown in FIG. 10B specifically, the main-scan resolution conversion block 1001 interpolates pixels in the main scanning direction in order to convert the resolution of the input multilevel data to a designated resolution. To calculate pixel data values to be interpolated, use may be made of a nearest pixel substituting method, a nearby two-pixel weighted averaging method, a cubic function convolution method or the like. More specifically, a plurality of FFs (Flip-Flops) 1003 store the pixel data while an interpolation pixel calculator 1004 calculates data values to be interpolated.

As shown in FIG. 10C specifically, the image data converted in resolution in the horizontal direction are fed from the main-scan resolution conversion block 1001, FIG. 10B, to the subscan resolution conversion block 1002. The subscan resolution conversion block 1002 includes a plurality of line memories 1005 each being capable of storing one line of image data converted in resolution in the main scanning direction. An interpolation pixel calculator 1007 calculates data to be interpolated on the basis of image data calculated in the subscanning direction. In this case, too, use may be made of a nearest pixel substituting method, a nearby two-pixel weighted averaging method, a cubic function convolution method or the like.

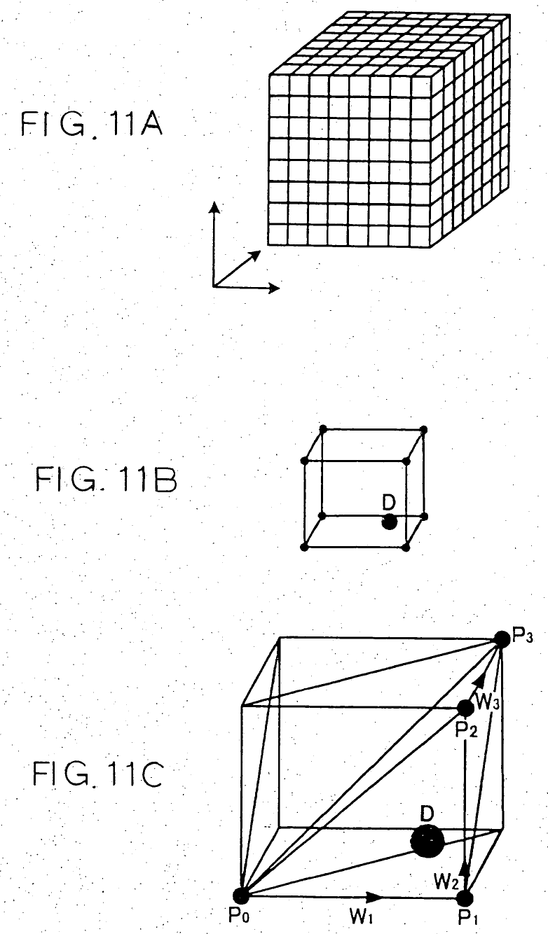

Next, the operation of the color space converter 604, FIG. 6, will be described specifically on the assumption that color space conversion is effected by a table interpolation method. A table interpolation method is such that an output corresponding to any input signal is generated by tridimensional interpolation using several output values close to the input value on the basis of an LUT (Look-UP Table). The LUT may be configured such that converted output values each are positioned at a particular lattice point of a space divided by preselected intervals. In the illustrative embodiment, as shown in FIG. 11A, axes in the x, y and z directions are divided into eight each while the input color space is divided into a higher portion and a lower portion. The color space converter 604 references the LUT by using the upper portion of the input color space and produces an accurate output by tridimensional interpolation by using the lower portion. The x, y and z axes maybe divided into sixteen or thirty-tow each, if desired.

While a number of different tridimensional interpolation methods are known in the art, a tetrahedron interpolation method, which is the simplest linear interpolation, is applied to the color space converter 604 by way of example. The tetrahedron interpolation method divides an input color space into a plurality of unit cubes, as shown in FIG. 11A, then selects one cube surrounding an input color D, as shown in FIG. 11B, and then divides the unit cube surrounding the input color D into six equal tetrahedrons, as shown in FIG. 11C. In FIG. 11C, P₀, P₁, P₂ and P₃ are representative of lattice points included in a color conversion table or LUT.

Subsequently, which of the six equal tetrahedrons contains the input color D is determined to thereby determine weighting coefficients W₁, W₂ and W₃. Then, an interpolation output (D) for the input color D may be produced on the basis of an output value (Pᵢ) at a lattice point Pᵢ by:

$$( D ) = ( {P}_{0} ) + {W}_{1} \times \{ ( {P}_{1} ) - ( {P}_{0} ) \} + {W}_{2} \times \{ ( {P}_{2} \} - ( {P}_{0} ) \} + {W}_{3} \times \{ ( {P}_{3} \} - ( {P}_{0} ) \}$$

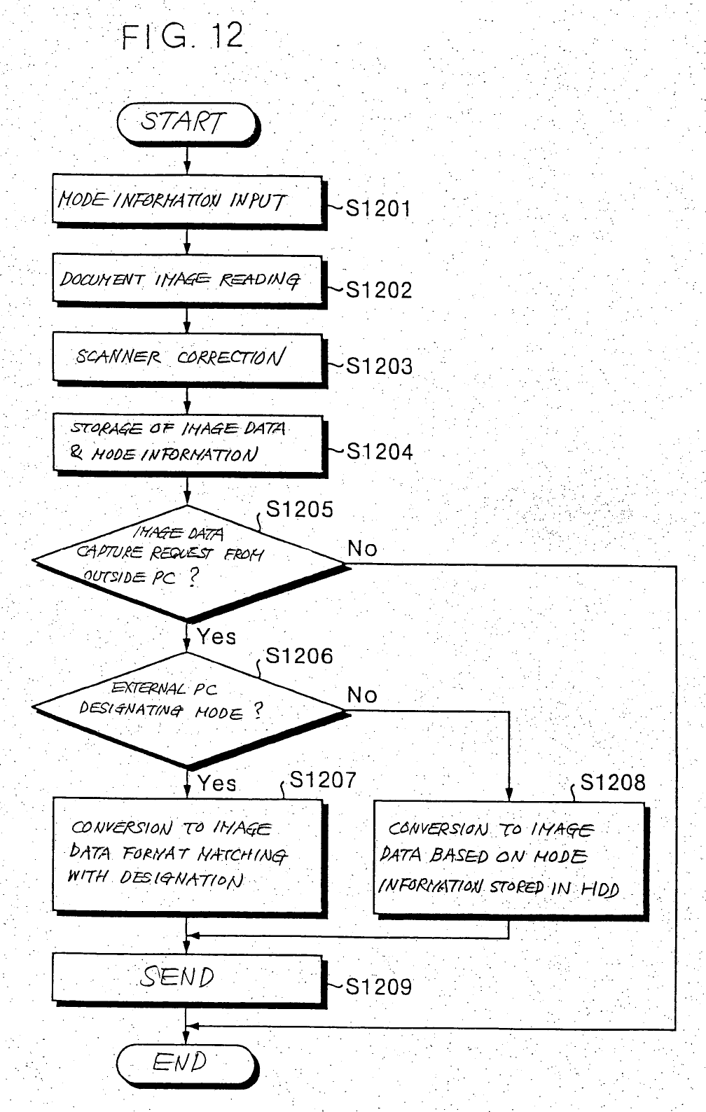

A specific procedure in which the image processing apparatus 100 generates image data and transmits them will be described with reference to FIG. 12. As shown, a processing mode or mode information relating to image data is input on the control panel 300 (step S1201). This processing mode is an image quality mode, i.e., a text mode, a text/photo mode or a photo mode. The processing mode additionally includes notch information for increasing or decreasing the density of a document image.

Subsequently, the reading unit 111 reads the image of a document (step S1202), and then the scanner corrector 112 executes scanner correction (step S1203). The scanner correction includes, e.g., scanner γ correction, filtering and magnification change and is executed in such a manner as to reflect the processing mode set in the step S1201 beforehand. The image data thus undergone scanning processing are written to the HDD or storing means 118 together with information representative of the mode set in the step S1201 (step S1204).

After the step S1204, the main controller 117 determines whether or not an image data request is received from the outside PC 126 (step S1205). If an image data request is not received from the PC 126 (No, step S1205), the procedure of FIG. 12 ends. On the other hand if an image data request is received from the PC 126 (Yes, step S1205), the controller 117 determines whether or not the PC 126 is designating a particular processing mode of desired image data (step S1206) The step S1206 is followed by a step S1207 if the answer of the step S1206 is Yes or followed by a step S1208 if otherwise.

In the step S1207, the data format converter 125 converts the format of the image data read out of the HDD 118 to a format matching with the processing mode designated by the PC 126. The image data with the converted format are transmitted to the PC 126 (step S1209). On the other hand, in the step S1208, the data format converter 125 converts the format of the image data read out of the HDD 118 to a format matching with the processing mode set in the step S1201. The image data output in the step S1201 are also transmitted to the PC 126 (step S1209).

It is to be noted that the image data are stored in or read out of the HDD 118 after preselected compression or preselected expansion, respectively.

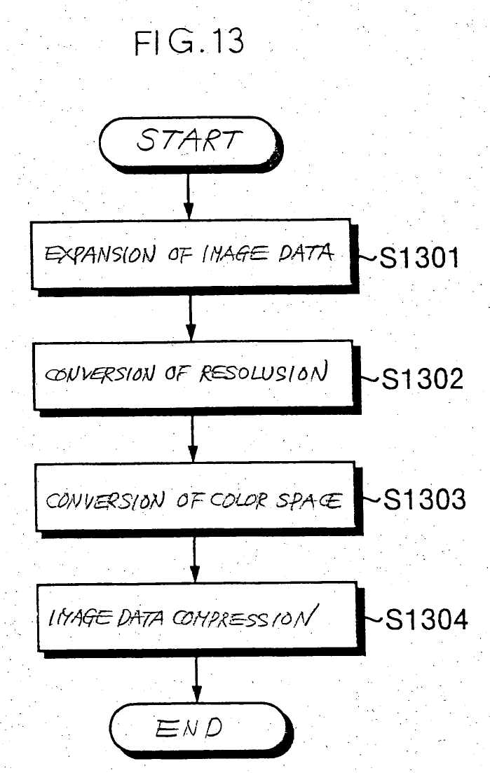

FIG. 13 demonstrates a specific image data format conversion procedure to be executed by the data format converter 125. While conversion that reflects a processing mode designated by the outside PC 126 and conversion that does not reflect it are shown as independent steps S1207 and step S1208 in FIG. 12, such steps are shown collectively in FIG. 13 because they are, in practice, the same as each other.

As shown in FIG. 13, the expander 602 expands the compressed image data read out of the hard HDD 118 to thereby restore the original image data (step S1301). Subsequently, the resolution converter 603 converts the resolution of the original image data thus restored (step S1302), and then the color space converter 604 converts the color space of the image data (step S1303). Thereafter, the compressor 605 compresses the image data subject such conversion before the image data are again output via the output port 606 (step S1304).

If desired image data should be processed in a mode designated by the outside PC 126, processing matching with the designated mode is executed in the steps S1302 and S1303. If no particular processing mode is designated by the PC 126, processing is executed on the basis of a processing mode stored in the HDD 118 and input on the control panel 300 is executed in the step S1302.

The data format converter 125 is capable of converting the format of the input image data to another format mainly in the step S1304, FIG. 13, if desired. More specifically, the data format converter 125 is capable of selectively outputting input image data input with a general-purpose format as image data with the same format, outputting input image data with an exclusive data after converting the format to a general-purpose format or outputting input image data with an exclusive format as image data with the same format, as desired. It should be noted that the format of image data to be output from the data format converter 125 is also determined by a processing mode designated by either one of the control panel or the output PC 126.

As stated above, the illustrative embodiment produces from a document image image data having a general-purpose format that can be commonly used by various kinds of image processing apparatuses, and then transmits the image with the general-purpose format to an outside apparatus. This successfully broadens the range of general-purpose application of image data.

An alternative embodiment of the present invention will be described hereinafter. Briefly, while image data undergone data format conversion in the embodiment described above are also color image data, such data are monochromatic image data in the alternative embodiment. The alternative embodiment is identical with the previous embodiment except for the configuration of the data format converter, so that the following description will concentrate on the configuration of the data format converter.

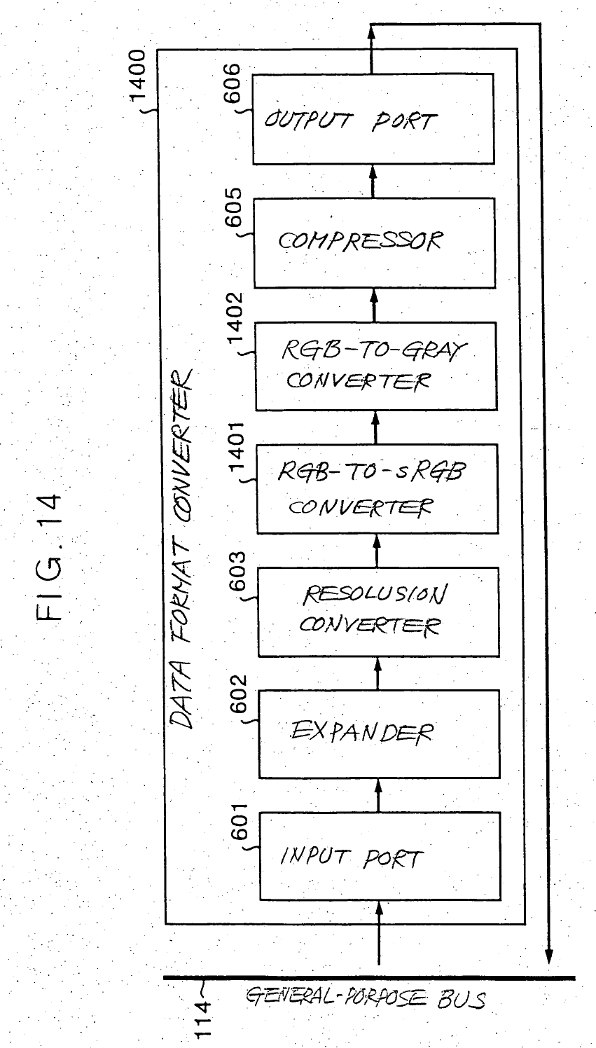

FIG. 14 is a schematic block diagram showing a specific configuration of a data format converter 1400 representative of the alternative embodiment. As shown, the image data and processing mode information output from the HDD 118 are input to an input port 601 via the general-purpose bus 114. The image data in a compressed state are then expanded by an expander 602. The image data thus expanded are provided with a resolution based on the processing mode by a resolution converter 603.

Subsequently, if the input image data are RGB image data particular to the image processing unit, an RGB-to-sRGB converter 1401 converts the color space of the image data to an sRGB or similar standard color space, and then an RGB-to-Gray converter 1402 converts the image data with the sRGB color space to monochromatic image data. The resulting output of the RGB-to-Gray converter 1402 is coded by the compressor 605 in a preselected compression format, fed to the general-purpose bus 114 via the output port 606 and then sent to, e.g., the outside PC 12. In this manner, the image data with a first format stored in the hard disk 118 are output as image data with a second format. In the illustrative embodiment, the RGB data particular to the image processing apparatus are converted to sRGB data and then converter to Gray or monochromatic-image data, so that Gray data based on the standard color space are obtained.

The input port 601, expander 602, resolution converter 603, compressor 605 and output port 606 are identical with the corresponding constituents of the previous embodiment and will not be described specifically in order to avoid redundancy.

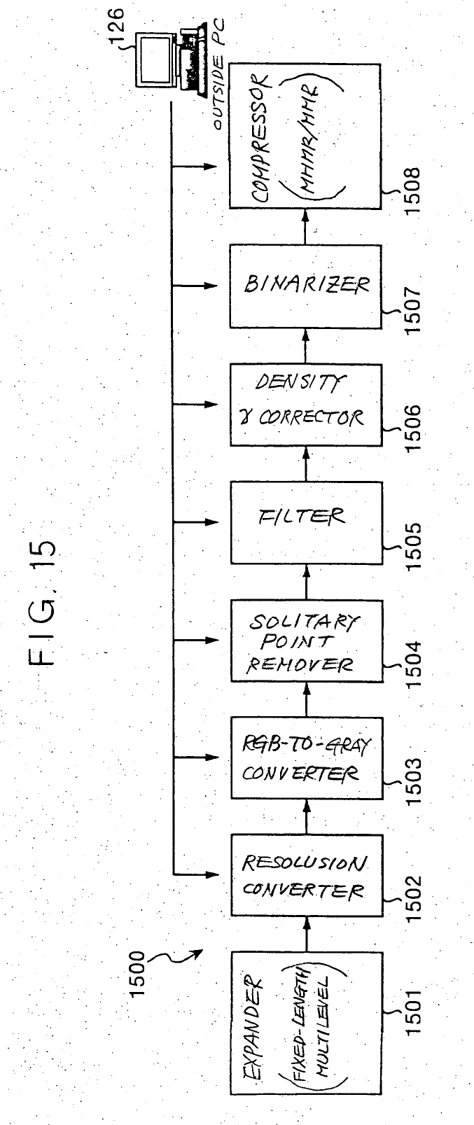

FIG. 15 shows another specific configuration of the data format converter 1400. In FIG. 15, blocks corresponding to the input port 601 and 606 are not shown. In this case, the image data stored in the hard disk 118 are assumed to represent an image compressed by the fixed-length multilevel compression system on the basis of an R, G and B color component basis by way of example.

As shown in FIG. 15, the data format converter, generally 1500, includes an expander 1501 for expanding the image data. A resolution converter 1502 converts the resolution of the image data output from the expander 1501 with a preselected magnification change ratio. An RGB-to-Gray converter 1503 converts the RGB image data to monochromatic image data. A solitary point eliminator 1504 eliminates solitary points contained in the monochromatic image data with a solitary point elimination algorithm. A filter 1505 executes enhancement or smoothing in the processing mode input on the control panel 300 or designated by the outside PC 126. A density γ corrector 1506 controls the density of the image. A bilevel processor 1507 binarizes the image data with a preselected scheme. A compressor 1508 compresses the resulting bilevel data with the MHMR/MMR or similar general-purpose data compression system.

The data format converter 1500 with the above configuration is capable of converting color-copy image data to monochromatic bilevel image data and send the bilevel image data to the external PC 126. More specifically, color image data needs a large capacity and therefore heavy load when input to the external PC 126, so that one may desire to convert color image data to monochromatic bilevel image data. The data format converter 1500 meets such a need.

The individual blocks constituting the data format converter 1500 will be described more specifically hereinafter. It is to be noted that the expander 1501, resolution converter 1502, RGB-to-Gray converter 150 and compressor 1508 are identical in configuration with the corresponding blocks of FIG. 14 and will not be described specifically in order to avoid redundancy.

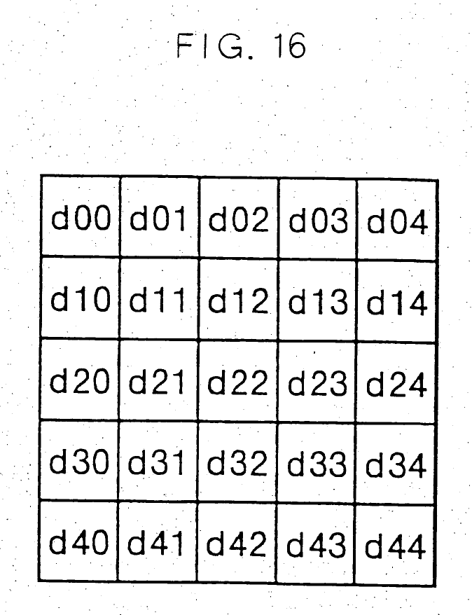

First, the operation of the solitary point eliminator 1504 will be described. Generally, if noise is contained in the original image, an output image often appears disagreeable. In such a case, the solitary point eliminator 1504 adaptively removes solitary points present in the original image. While various algorithms are available for the elimination of solitary points, the solitary point eliminator 1504 is assumed to use a method using a matrix shown in FIG. 16.

FIG. 16 shows a specific matrix consisting of 5×5 blocks d00 through d44 and with which the solitary point eliminator 1504 makes a decision on a solitary point. In FIG. 16, the block or pixel d22 is a pixel being observed. If all pixels other than he pixel d22 being observed are lower than a preselected threshold value TH1, then the pixel d22 is replaced with a white pixel, i.e., a pixel value of zero. This processing is successful to remove solitary points or noise contained in the image read by the reading unit 111.

While the elimination of solitary points is effective when the image data stored in the HDD 118 are representative of a natural image, such processing is not necessary when the image data are electronically generated, e.g., printer RIP (Raster Image Processor) data. In light of this, operation parameters for the elimination of solitary points may be switched in accordance with the kind of an image to be sent to the external PC 126 in order to insure high-quality images.

As for the filter 1505, the illustrative embodiment varies its processing in accordance with the processing mode input on the control panel 300 and the resolution designated by the outside PC 126, thereby producing an optimum image matching with the purpose of pickup. While filtering refers to modulating the MTF (Modulation Transfer Function) of image data, the MTF may be enhanced to improve image quality if the original image mainly consists of characters or may be slightly smoothed to render the resulting image smooth and therefore high-quality if the original image mainly consists of graphics. In addition, filtering may be used to correct the deterioration of an image occurred in the resolution converting step. In this manner, by selecting a particular filter coefficient matching with the kind of an image, it is possible to produce attractive images.

The density γ corrector 1506 is, in the aspect hardware, implemented by an LUT implemented by a RAM (Random Access Memory). γ correction makes the density gradient and density characteristic of an image variable. More specifically, the setting of the density γ corrector 1506 is suitably varied in accordance with the processing mode input on the operation panel 300 or desired density information received from the outside PC 126, so that an image can be output in accordance with the mode of storage or with density desired by the operator of the external PC 126.

The binarizer 1507 converts the multilevel image data to bilevel image data by halftone processing. While halftone processing refers to quantizing multilevel image data to image data of two levels or similar small number of gradation levels, various halftone processing schemes are available in the imaging art. Let the following description concentrate on a simple quantizing method, a dither method and an error diffusion method conventional in the imaging art. The number of gradation levels for quantization is assumed to be two by way of example.

The simple quantizing method binarizes input image data by using any suitable value included in the dynamic range of multilevel image data as a threshold value. For example, assume that the multilevel image data to be binarized has a dynamic range of from “0” to “255”, i.e., 256 gradation levels in total, and that the threshold value is “128”. Then, the quantized value is a (logical) ZERO if the image data is “100” or a (logical) ONE if it is “200”.

The dither method binarizes multilevel image data pixel by pixel by using a matrix of threshold values. If the threshold values in the matrix are determined in such a manner as to be scattered in the dynamic range of image data, halftone can be reproduced even from the binarized image data although it is a tradeoff with resolution.

The error distribution method binarizes multilevel image data by using any suitable threshold value like the simple quantizing method. However, the error distribution method fifers from the simple quantizing method in that it stores errors occurring during quantization and quantizes a pixel being observed by taking account of the errors of surrounding pixels already quantized in a raster type order and having errors fixed, thereby minimizing the quantization error of the total image data.

By using any one of the specific methods stated above, the binarizer 1507 is capable of binarizing the input multilevel image data to thereby reduce the total amount of data and select halftone processing matching with the kind of an image and therefore to enhance image quality. It is to be noted that by suitably varying the halftone processing system in accordance with the processing mode input on the control panel or image mode information received from the external PC 126, it is possible to selectively output an image based on a mode in which image data are stored or an image designated by the operator of the outside PC 126.

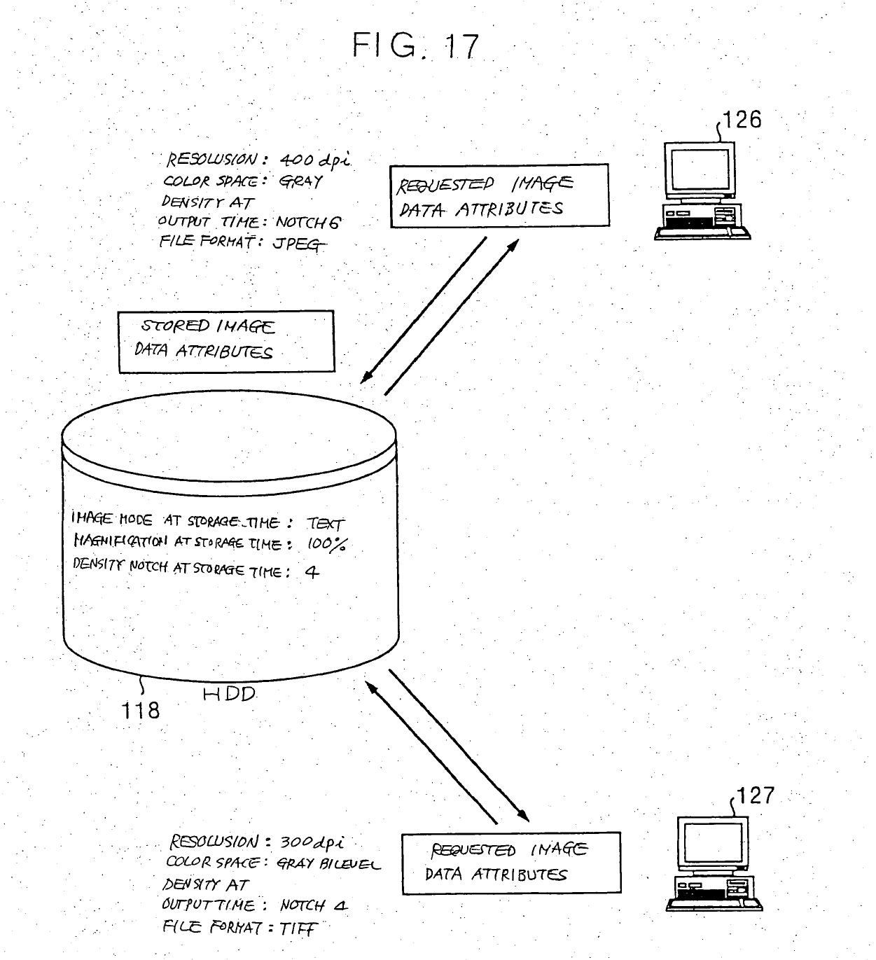

A specific sequence in which the image data stored in the HDD 118 are sent to, e.g., external PCs will be described with reference to FIG. 17. As shown, external PCs 126 and 127 each determine particular attributes for capturing an image. An image data parameter value of the data format converter 1500 is determined on the basis of capture requests received from the outside PC 126 and 127 and the processing modes input from the control panel 300 and stored in the HDD 118 in association with the image data. The parameters of the resolution converter 1502, filter 1505, density corrector 1506, binarizer 1507 and compressor 1508 shown in FIG. 15 by way of example are varied in accordance with the above parameter. After image processing, the designated images are sent to the outside PCs 126 and 127.

It is to be noted that the image data stored in the HDD 118 are assumed to be image data read by a color copier as a color image and belonging to a certain color space.

As shown in FIG. 17, assume that the image data stored in the HDD 118 have the following attributes:

resolution: 600 dpi (dots per inch)

color space: RGB

compression: block compression particular to an apparatus

image quality mode at the time of storage: text mode

magnification at the time of storage: 100%

density notch at the time of storage: 4

The outside PC 126 requests to receive or capture image data with attributes of a resolution of 400 dpi, a Gray color space, a notch 6 at the time of output and a file format of JPEG image. The other outside PC 127 requests to capture image data with attributes of a resolution of 300 dpi, a Gray belevel color space, a notch of 4 at the time of output and a file format of TIFF.

The data format converter 1500 executes image processing meeting the requests of the external PCs 126 and 127. More specifically, because the image data stored in the HDD 118 are of block compression particular to the apparatus, the expander 1401 compresses the image data to non-compressed image data. Next, the resolution converter 1502 determines conversion parameters on the basis of the resolutions requested by the outside PCs 127 and 127 and the resolutions of the image data stored in the HDD 118 and then converts the image data for the PC126 from 600 dpi to 400 dpi and converts the image data for the PC 127 from 600 dpi to 300 dpi.

Subsequently, the RGB-to-Gray converter 1503 converts the RGB color space to the gray scale. In the alternative embodiment stated earlier, while filtering is effected in the event of storage of image data in the HDD 118, filtering is suitably effected when, e.g. characters are deteriorated due to resolution conversion. Also, because the alternative embodiment does not execute correction when image data are written to the hard disk 118, the image mode and node notch of image data are written to the HDD 118 together with the image data, so that the node γ corrector 1506 can control density γ at the time of output to the external PCs 126 and 127 by referencing the image mode and node notch stored. On the other hand, when a change of notch is commanded by the PC 126 or 127, the node γ corrector 1506 controls density γ in accordance with the notch information.

Thereafter, the compressor 1508 converts the file format to the JPEG format for the external PC 126 and converts the file format to the TIFF file format with MHMR compression for the external PC 1271.

When the external PC 126 or 127 holds the same attributes stored in the HDD 118 thereafter together with image data, it does not have to again designate the attributes of image data to capture because the processing modes input on the control panel 300 are stored in the HDD 118.

A specific image data generation and transmission procedure unique of the alternative embodiment is practicable with the procedure shown in FIG. 12 and will not be described specifically in order to avoid redundancy. Also, the image data format conversion processing is generally similar to the processing described with reference to FIG. 13 except that conventional processing for converting color image data to monochromatic image data is inserted between the steps S1301 and S1302.

In summary, it will be seen that the present invention provides an image processing apparatus, an image processing method and an image processing program capable of generating from read document image image data with a general-use format and a small capacity applicable to various kinds of image processing apparatuses and send such image data to an external apparatus to thereby enhance efficient data transmission and general-purpose application of data.

It is to be noted that the image processing method shown and described be implemented as, e.g., a program prepared beforehand to be executed by a personal computer, work station or similar computer. In such a case, the program is stored in a hard disk, flexible disk CD-ROM, MO, DVD or similar recording medium that can be ready by a computer. Alternatively, such a program may be implemented as a transmission medium that can be distributed via Internet or similar network.

More specifically, in accordance with the present invention, there can be executed image processing adaptive to a processing mode, e.g., copy mode, a printer mode, a scanner mode or a facsimile mode based on the selection by application selecting means and image quality mode sensing means in order to convert the processing mode to a data of a format of general use and then output. The image data can therefore be repeatedly used and easily controlled.

In accordance with the image processing apparatus, image processing method and image processing program, there can be generated from read document image image data with a general-use format and a small capacity applicable to various kinds of image processing apparatuses and send such image data to an external apparatus to thereby enhance efficient data transmission and general-purpose application of data.

Thus, the image processing apparatus, image processing method and image processing program is advantageously applicable to image processing of the type reading a document image and then generating image data therefrom, particularly when the image data once processed in the apparatus are used by an external apparatus.

Various modifications will become possible for those skilled in the art after receiving the teachings of the present disclosure without departing from the scope thereof.

What is claimed is:

1. An image processing apparatus comprising:
application mode selecting means for selecting an application;
image quality mode selecting means for selecting an image quality mode;
image reading means for generating a preselected color image signal by reading a document image;
scanner correcting means for executing image processing with the color image signal in accordance with the application and the image mode selected by said application mode selecting means and by said image mode selecting means, respectively, to thereby generate color image data;
storing means for storing the image data generated by said scanner correcting,means and information representative a processing mode based on the application and the image mode selected by said application selecting means and said image mode selecting means;
data compressing/expanding means for selectively compressing or expanding the image data;
data format converting means for converting a format of the image data stored in said storing means in matching relation to the processing mode;
communicating means for interchanging various data with an external apparatus; and
control means for controlling an entire apparatus

2. The apparatus as claimed in claim 1, wherein said data format converting means comprises:
data expanding means for expanding compressed image data and input resulting expanded image data; and
data compressing means for compressing the image data undergone preselected image processing and output resulting compressed image data.

3. The apparatus as claimed in claim 2, wherein when input the image data and the output image data both are general-purpose data, said data format converting means expands said general-purpose data with an expander, executes preselected image processing with an image processor, compresses said general-purpose data and then outputs resulting compressed data.

4. The apparatus as claimed in claim 3, wherein said data format converting means further comprising resolution converting means for converting a resolution of the input image data.

5. The apparatus as claimed in claim 4, wherein said data format converting means further comprises color space converting means for converting a color space of the input image data to a color space not dependent on an apparatus characteristic.

6. The apparatus as claimed in claim 5, wherein data format converting means further comprise monochrome converting means for converting input color image data to a monochromatic image data.

7. The apparatus as claimed in claim 2, wherein when the input image data and the output image data are exclusive image data and general-purpose image data, respectively, said data format converting means expands said exclusive image data with an expander, executes image processing with an image processing section, compressing said general-purpose image data with a compressor and then output resulting compressed image data.

8. The apparatus as claimed in claim 7, wherein said data format converting means further includes resolution converting means for converting a resolution of input image data.

9. The apparatus as claimed in claim 8, wherein said data format converting means further comprises color space converting means for converting a color space of the input image data to a color space not dependent on an apparatus characteristic.

10. The apparatus as claimed in claim 9, wherein said data format converting means further comprises monochrome converting means for converting input color image data to a monochromatic image data.

11. The apparatus as claimed in claim 2, wherein when the input image data and the output image data are exclusive image data and general-purpose image data, respectively, said data format converting means expands said exclusive image data with an expander, executes image processing with an image processing section, compresses said general-purpose image data with a compressor and then outputs resulting compressed image data.

12. The apparatus as claimed in claim 11, wherein said data format converting means further comprises resolution converting means for converting a resolution of input image data.

13. The apparatus as claimed in claim 12, wherein said data format converting means further comprises color space converting means for converting a color space of the input image data to a color space not dependent on an apparatus characteristic.

14. The apparatus as claimed in claim 3, wherein said data format converting means further comprises monochrome converting means for converting input color image data to monochromatic image data.

15. The apparatus as claimed in claim 2, wherein when a processing mode set by an external apparatus is received via said communicating means, said data format converting means converts a format of the image data in accordance with said processing mode.

16. An image processing method comprising:
an application mode selecting step of selecting an application;
an image quality mode selecting step of selecting an image quality mode;
an image reading step of generating a preselected color image signal by reading a document image;
a scanner correcting step of executing image processing with the color image signal in accordance with the application and the image mode selected by said application mode selecting step and by said image mode selecting step, respectively, to thereby generate color image data;
a storing step of storing the image data generated by said scanner correcting step and information representative a processing mode based on the application and the image mode selected by said application selecting step and said image mode selecting step;
a data compressing/expanding step of selectively compressing or expanding the image data;
a data format converting step of converting a format of the image data stored in said storing step in matching relation to the processing mode;
a communicating step of interchanging various data with an external apparatus; and
a controlling step of controlling an entire apparatus

17. The method as claimed in claim 16, wherein said data format converting step comprises:
a data expanding step of expanding compressed image data and input resulting expanded image data; and
a data compressing step of compressing the image data undergone preselected image processing and output resulting compressed image data.

18. The method as claimed in claim 17, wherein when input the image data and the output image data both are general-purpose data, said data format converting step expands said general-purpose data with an expander, executes preselected image processing with an image processor, compress said general-purpose data and then outputs resulting compressed data.

19. The method as claimed in claim 18, wherein said data format converting step further comprising a resolution converting step of converting a resolution of the input image data.

20. The method as claimed in claim 19, wherein said data format converting step further comprises a color space converting step of converting a color space of the input image data to a color space not dependent on an apparatus characteristic.

21. The method as claimed in claim 20, wherein said data format converting step further comprises a monochrome converting step of converting input color image data to monochromatic image data.

22. The method as claimed in claim 21, wherein said data format converting step further comprises a solitary point removing step of executing solitary point removal with input image data.

23. The method as claimed in claim 22, wherein said data format converting step further comprises a filtering step of executing preselected filtering step with input image data.

24. the method as claimed in claim 23, wherein said data format converting step further comprises a density γ processing step of executing preselected density γ processing with input image data.

25. The method as claimed in claim 24, wherein said data format converting step further comprising a binarizing step of converting input multilevel data to bilevel image data.

26. The method as claimed in claim 17, wherein when the input image data and the output image data are exclusive image data and general-purpose image data, respectively, said data format converting step expands said exclusive image data with an expander, executes image processing with an image processing section, compresses said general-purpose image data with a compressor and then outputs resulting compressed image data.

27. The method as claimed in claim 26, wherein said data format converting step further comprises a resolution converting step of converting a resolution of input image data.

28. The method as claimed in claim 27, wherein said data format converting step further comprises a color space converting step of converting a color space of the input image data to a color space not dependent on an apparatus characteristic.

29. The method as claimed in claim 28, wherein said data format converting step further comprises a monochrome converting step for converting input color image data to monochromatic image data.

30. The method as claimed in claim 29, wherein said data format converting,step comprises a solitary point removing step of executing solitary point removal with input image data.

31. The method as claimed in claim 30, wherein said data format converting step further comprises a filtering step of executing preselected filtering step with input image data.

32. The method as claimed in claim 31, wherein said data format converting step further comprises a density γ processing step of executing preselected density γ processing with input image data.

33. The method as claimed in claim 32, wherein said data format converting step further comprising a binarizing step of converting input multilevel data to bilevel image data.

34. The method as claimed in claim 17, wherein when the input image data and the output image data are exclusive image data and general-purpose image data, respectively, said data format converting step expands said exclusive image data with an expander, executes image processing with an image processing section, compresses said general-purpose image data with a compressor and then outputs resulting compressed image data.

35. The method as claimed in claim 34, wherein said data format converting step further comprises a resolution converting step of converting a resolution of input image data.

36. The method as claimed in claim 35, wherein said data format converting step further comprises a color space converting step of converting a color space of the input image data to a color space not dependent on an apparatus characteristic.

37. The method as claimed in claim 36, wherein data format converting step further comprises a monochrome converting step for converting input color image data to monochromatic image data.

38. The method as claimed in claim 37, wherein said data format converting step comprises a solitary point removing step of executing solitary point removal with input image data.

39. The method as claimed in claim 38, wherein said data format converting step further comprises a filtering step of executing preselected filtering step with input image data.

40. The method as claimed in claim 39, wherein said data format converting step further comprises a density γ processing step of executing preselected density γ processing with input image data.

41. The method as claimed in claim 40, wherein said data format converting step further comprising a binarizing step of converting input multilevel data to bilevel image data.

42. The method as claimed in claim 16, wherein when a processing mode et by an external apparatus is received via said communicating step, said data format converting step converts a format of the image data in accordance with said processing mode.

43. In an image processing program for causing a computer to execute an image processing method, said image processing method comprising:
an application mode selecting step of selecting an application;
an image quality mode selecting step of selecting an image quality mode;
an image reading step of generating a preselected color image signal by reading a document image;
a scanner correcting step of executing image processing with the color image signal in accordance with the application and the image mode selected by said application mode selecting step and by said image mode selecting step, respectively, to thereby generate color image data;
a storing step of storing the image data generated by said scanner correcting step and information representative a processing mode based on the application and the image mode selected by said application selecting step and said image mode selecting step;
a data compressing/expanding step of selectively compressing or expanding the image data;
a data format converting step of converting a format of the image data stored in said storing step in matching relation to the processing mode;
a communicating step of interchanging various data with an external apparatus; and
a controlling step of controlling an entire apparatus.

44. An image processing apparatus comprising:
an application mode selector configured to select an application;
an image quality mode selector configured to select an image quality mode;
a reading section configured to generate a preselected color image signal by reading a document image;
a scanner corrector configured to execute image processing with the color image signal in accordance with the application and the image mode selected by said application mode selector and said image mode selector, respectively, to thereby generate color image data;
a storage configured to store the image data generated by said scanner corrector and information representative a processing mode based on the application and the image mode selected by said application selector and said image mode selector;
a data compressor/expander configured to selectively compress or expand the image data;
a data format converter configured to convert a format of the image data stored in said storage in matching relation to the processing mode;
a communicating circuit configured to interchange various data with an external apparatus; and
a controller configured to control an entire apparatus.

45. The apparatus as claimed in claim 44, wherein said data format converter comprises:
a data expander configured to expand compressed image data and input resulting expanded image data; and
a data compressor configured to compress the image data undergone preselected image processing and output resulting compressed image data.

46. The apparatus as claimed in claim 45, wherein when input the image data and the output image data both are general-purpose data, said data format converter expands said general-purpose data with an expander, executes preselected image processing with an image processor, compresses said general-purpose data and then outputs resulting compressed data.

47. The apparatus as claimed in claim 46, wherein said data format converter further comprising a resolution converter configured to convert a resolution of the input image data.

48. The apparatus as claimed in claim 47, wherein said data format converter further comprises a color space converter configured to convert a color space of the input image data to a color space not dependent on an apparatus characteristic.

49. The apparatus as claimed in claim 48, wherein data format converter further comprises a monochrome converter configured to convert input color image data to a monochromatic image data.

50. The apparatus as claimed in claim 45, wherein when the input image data and the output image data are exclusive image data and general-purpose image data, respectively, said data format converter expands said exclusive image data with an expander, executes image processing with an image processing section, compresses said general-purpose image data with a compressor and then output resulting compressed image data.

51. The apparatus as claimed in claim 50, wherein said data format converter further includes a resolution converter configured to convert a resolution of input image data.

52. The apparatus as claimed in claim 51, wherein said data format converter further comprises a color space converter configured to convert a color space of the input image data to a color space not dependent on an apparatus characteristic.

53. The apparatus as claimed in claim 52, wherein said data format converter further comprise monochrome converting means for converting input color image data to a monochromatic image data.

54. The apparatus as claimed in claim 45, wherein when the input image data and the output image data are exclusive image data and general-purpose image data, respectively, said data format converter expands said exclusive image data with an expander, executes image processing with an image processing section, compresses said general-purpose image data with a compressor and then outputs resulting compressed image data.

55. The apparatus as claimed in claim 54, wherein said data format converter further comprises a resolution converter configured to convert a resolution of input image data.

56. The apparatus as claimed in claim 55, wherein said data format converter further comprises color a space converter configured to convert a color space of the input image data to a color space not dependent on an apparatus characteristic.

57. The apparatus as claimed in claim 56, wherein said data format converter further comprises a monochrome converter configured to convert input color image data to monochromatic image data.

58. The apparatus as claimed in claim 44, wherein when a processing mode set by an external apparatus is received via said communicating circuit, said data format converter converts a format of the image data in accordance with said processing mode.
